(19) United States
(12) Patent Application Publication
(10) Pub. No.: US 2026/0112596 A1
(43) Pub. Date: Apr. 23, 2026

(54) Park Mass Over-Resolved Bandpass to Reduce Ion Path Contamination

(71) Applicant: DH Technologies Development Pte. Ltd., Singapore (SG)

(72) Inventor: Bruce COLLINGS, Concord (CA)

(21) Appl. No.: 19/121,714

(22) PCT Filed: Oct. 11, 2023
(86) PCT No.: PCT/IB2023/060242

§ 371 Date: Apr. 16, 2025

Related U.S. Application Data
(60) Provisional application No. 63/417,178, filed on Oct. 18, 2022.

(51) Int. Cl. H01J 49/42; H01J 49/00; H01J 49/06

(52) U.S. Cl. CPC H01J 49/4215; H01J 49/0031; H01J 49/067; H01J 49/426

(57) ABSTRACT

In one aspect, a method of operating a mass spectrometer having an ion source, at least one ion optic positioned downstream of the ion source and at least one ion mass filter positioned downstream of the ion optic is disclosed, which includes transitioning an operational mode of the mass spectrometer from an active mass collection mode to a park mass mode, and configuring the ion optic to function as a bandpass ion filter for substantially inhibiting passage of ions generated by the ion source during the park mass mode to the downstream ion mass filter.

### CROSS-REFERENCE TO RELATED APPLICATIONS

This PCT application claims the benefit under 35 U.S.C. § 119(e) of Application Ser. No. 63/417,178 filed on Oct. 18, 2022, entitled “Park Mass Over-Resolved Bandpass to Reduce Ion Path Contamination” and whose entire disclosure is incorporated by reference herein.

### TECHNICAL FIELD

The present disclosure relates to methods and systems for performing mass spectrometry and more particularly to such methods and systems that allow configuring a mass spectrometer so as to reduce, and preferably eliminate, contamination of one or more components employed in the mass spectrometer, such as mass filters and ion lenses, when the mass spectrometer is in a park mass mode.

### BACKGROUND

Mass spectrometry (MS) is an analytical technique for determining the elemental composition of a substance. Specifically, MS measures a mass-to-charge ratio (m/z) of ions generated from a test substance. MS can be used to identify unknown compounds, to determine isotopic composition of elements in a molecule, to determine the structure of a particular compound by observing its fragmentation, and to quantify the amount of a particular compound in a sample. Mass spectrometers detect ions and as such, a test sample must be converted to an ionic form during mass analysis.

Generally, a mass spectrometer includes an ion source, an analyzer, and a detector. The ion source converts a test sample into gaseous ions, the mass analyzer separates (or mass analyzes) the gaseous ions based on their m/z ratios, and the detector detects the separated ions. One or more ion mass filters are often installed between the ion source and the analyzer to isolate the precursor ions. Further, one or more dissociation devices are often installed between the isolation device and the analyzer to dissociate the isolated precursor ions for tandem mass spectrometry.

In use, there are often periods of time when the mass spectrometer is idle while the ion source is still generating ions. During such periods, the ions can be deposited onto one or more mass filters positioned downstream of the ion source. Such deposition of the ions can cause contamination of the mass filters and degrade their performance during mass analysis of compounds.

### SUMMARY

In one aspect, a method of operating a mass spectrometer having an ion source, at least one ion optic positioned downstream of the ion source and at least one ion mass filter positioned downstream of the ion optic is disclosed, which includes transitioning an operational mode of the mass spectrometer from an active mass collection mode to a park mass mode, and configuring the ion optic to function as a bandpass ion filter for substantially inhibiting passage of ions generated by the ion source during the park mass mode to the downstream ion mass filter.

In some embodiments, the ion optic can include a plurality of rods that are arranged in a multipole configuration. Some examples of such a multipole configuration includes a quadrupole, a hexapole and an octupole configuration. In some such embodiments, RF and offset DC voltages can be applied to the rods such that the ion optic would function as an ion guide for facilitating focusing of the ions into a downstream ion mass filter during active operation of the mass spectrometer, i.e., during periods where mass data is being collected. In response to transition of the operational mode of the mass spectrometer into a park mass mode, a resolving DC voltage can be applied to one or more rods of the ion optic such that the ion optic would function as an ion mass filter to substantially inhibit the passage of ions generated by an upstream ion source into the ion mass filter. For example, the resolving DC voltage can be selected to inhibit passage of ions having m/z ratios within a transmission window where the width and the center of the transmission window in the mass space are determined by the RF amplitude and the magnitude of the resolving DC voltage.

In some embodiments, the ion optic has a segmented structure comprising a plurality of ion optic segments that are positioned in tandem relative to one another, where each ion optic segment includes a plurality of rods that are arranged in a multipole configuration.

In some embodiments, the RF and DC resolving voltages applied to the rods of the ion optic to configure the ion optic as a mass filter can be determined based on the mass of the ions for which filtering is required as discussed in more detail below.

In a related aspect, a mass spectrometer is disclosed, which includes an ion source for receiving a sample and ionizing at least a portion of the received sample to generate a plurality of ions, an ion optic positioned downstream of the ion source for receiving the plurality of ions and focusing the ions to form an ion beam, an ion mass filter positioned downstream of said ion optic for receiving said ion beam, and a controller in communication with the ion optic. The controller is configured to adjust a DC resolving voltage applied to the ion optic such that the ion optic functions as an ion mass filter for substantially inhibiting passage of the received ions to the downstream ion mass filter when said mass spectrometer is in a park mass mode.

In some embodiments, the ion optic can include a plurality of rods arranged in a multipole configuration and the DC resolving voltage(s) is applied to those rods.

The mass spectrometer can include a DC voltage source and an RF voltage source operating under control of the controller for applying RF and DC voltages to the rods of the ion optic. While in some embodiments, the DC and RF voltage sources can be implemented as separate units, in other embodiments they can be integrated within a single power supply unit.

During the mass data collection, the DC voltages applied to the rods of the ion optic provide a DC offset voltage between the ion optic relative to upstream and downstream components to facilitate the introduction of ions into the ion optic and their passage through the ion optic. During the park mass mode, a resolving DC voltage can be applied to the rods to cause the ions entering the ion optic to have unstable trajectories and hence be inhibited from passage through the ion optic (e.g., they can collide with the rods of the ion optic). The DC offset voltages can be retained during the park mass mode.

In some embodiments, the ion optic can include a plurality of ion optic segments that are positioned in tandem relative to one another. In some such embodiments, the resolving DC voltage is applied to one of the segments.

In some embodiments, the controller can cause the DC voltage source to apply DC offset voltages to said plurality of segments. The DC offset voltages can be configured to accelerate passage of ions through segmented ion guide by increasing the ions' kinetic energy.

Further understanding of various aspects of the present teachings can be obtained by reference to the following detailed description and the associated drawings, which are briefly described below.

### BRIEF DESCRIPTION OF THE DRAWINGS

FIG. 1 is a flow chart depicting various steps in an embodiment of a method for performing mass spectrometry,

FIG. 2A schematically depicts a mass spectrometer according to an embodiment,

FIG. 2B is a schematic partial view of the mass spectrometer depicted in FIG. 2A,

FIG. 2C schematically shows application of RF and DC voltages to the rods of the Q0C segment in one embodiment of the present teachings,

FIG. 2D is a partial view of the mass spectrometer depicted in FIG. 2A,

FIG. 2E shows schematically that for each of the four rod sets Q0A, Q0B, Q0C, and Q0D, the rods marked ‘A’ are electrically connected, and are referred to as the A-pole and the rods marked ‘B’ are electrically connected and are referred to as the B-pole,

FIG. 3A shows a mass spectrum of PPG's obtained using a triple quadrupole mass spectrometer with no bandpass applied to the Q0 ion optic,

FIG. 3B shows a mass spectrum of PPG's obtained using the same quadrupole mass spectrometer as that used to obtain the data shown in FIG. 3A with a 30 Da wide bandpass centered at m/z 715 applied to Q0 ion optic,

FIG. 3C shows mass data obtained for PPG's using the same quadrupole mass spectrometer with an over-resolved bandpass centered at m/z 750 applied to the Q0 ion optic,

FIG. 4 shows mass data that was collected by setting the Q0 bandpass centered on m/z 609 while the Q1 mass filter was scanned from m/z 606 to 612 at 10 Da/s,

FIG. 5 shows scan lines for the bandpass windows of FIG. 4 along with the calculated Mathieu parameter q,a values for the increased resolving DC which reside outside of the stability region shown by the enclosed triangle,

FIG. 6A shows the locations along the ion path, as the ions travel through Q0 and Q1, at which ions are expected to be deposited when Q0 is operated without a bandpass window applied to the Q0C segment,

FIG. 6B schematically shows the fraction of ions passing through the Q0, IQ1 and ST1 that are expected to be deposited on the Q1 mass filter,

FIG. 7A schematically depicts the expected deposition of ions along their propagation path when a bandpass is applied to the Q0C segment,

FIG. 7B schematically shows the fraction of ions passing through the Q0, IQ1 and ST1 that are expected to be deposited on the Q1 mass filter when a bandpass is applied to the Q0C segment,

FIG. 8A schematically represents expected ion deposition on Q0A and Q0C segments when the resolving DC voltage applied to the Q0C segment is increased so that all ions are unstable as they pass through the Q0C segment, and

FIG. 8B schematically depicts that in example shown in FIG. 8A, no ions pass through the Q0C segment.

### DETAILED DESCRIPTION

It will be appreciated that for clarity, the following discussion will explicate various aspects of embodiments of the applicant's teachings, while omitting certain specific details wherever convenient or appropriate to do so. For example, discussion of like or analogous features in alternative embodiments may be somewhat abbreviated. Well-known ideas or concepts may also for brevity not be discussed in any great detail. The skilled person will recognize that some embodiments of the applicant's teachings may not require certain of the specifically described details in every implementation, which are set forth herein only to provide a thorough understanding of the embodiments. Similarly, it will be apparent that the described embodiments may be susceptible to alteration or variation according to common general knowledge without departing from the scope of the disclosure. The following detailed description of embodiments is not to be regarded as limiting the scope of the applicant's teachings in any manner.

When a mass spectrometer is undergoing final test procedures, or during development of mass spectrometric methods or performing exploratory work, there are often time periods in which the mass spectrometer is idle but the ion source (e.g., an electrospray ion source) continues to generate ions. During these time periods, the mass spectrometer is in the park mass mode with ions being deposited on a mass filter, e.g., a mass filter configured at a mid-mass setting with a resolving DC voltage that is set high enough so that all ions received by the ion filter are deposited on the ion filter and its associated ion lens. Such ion deposition can lead to contamination of the ion mass filter and the lens.

The present disclosure relates generally to systems and methods for use in a mass spectrometer for reducing and preferably eliminating such contamination of certain components of the mass spectrometer when the mass spectrometer is in a park mass operational mode, i.e., when mass data is not being collected but the ion source continues to generate ions. As discussed below, in embodiments, during the park mass mode, an ion guide positioned upstream of an ion mass filter of the mass spectrometer can be configured as a bandpass ion mass filter so as to inhibit the passage of at least a portion of the ions into the downstream ion mass filter. By way of example, in some such embodiments, the ion guide can be configured as a mass filter operating in an over-resolved mode to prevent the passage of all ions entering into the ion guide to the downstream ion mass filter. Further, it was discovered that a segmented ion optic, such as the segmented ion guide discussed in more detail below, can be more robust to contamination. The present teachings, and in particular the implementation of the present teachings with a segmented ion guide, can advantageously extend the operational lifetime of the ion mass filter and its associated ion lens.

Various terms are used herein in accordance with their ordinary meanings in the art. The terms “active operational mode” and “active mass collection mode” are used herein interchangeably to refer to an operational mode of the mass spectrometer in which the mass spectrometer is being used for collecting mass data, e.g., for performing mass analysis of a sample. The terms “park mass mode” and “park mass operational mode” are used herein interchangeably to refer to an operational mode of the mass spectrometer in which the mass spectrometer is idle, i.e., no mass data is being collected, although the mass spectrometer's ion source continues to generate ions.

The terms “bandpass filter,” “ion bandpass filter,” “ion bandpass mass filter” and similar terms as used herein to refer to an ion filter that provides an ion mass transmission window extending between a lower and an upper m/z cut-off, where ions received by the mass filter having m/z ratios within the ion mass transmission window can pass through the filter and ions with m/z ratios below the lower m/z cut-off as well as ions with m/z ratios above the upper m/z cut-off are inhibited from passage through the ion mass filter, e.g., due to experiencing unstable ion trajectories.

The term over-resolved mode as used herein to describe an ion mass filter refers to a configuration of the ion mass filter in which no ions that are received by the ion mass filter can pass through the filter. In other words, the ion mass filter configured to operate in an over-resolved mode inhibits passage of all ions entering the ion mass filter to downstream components, such as a downstream ion mass filter.

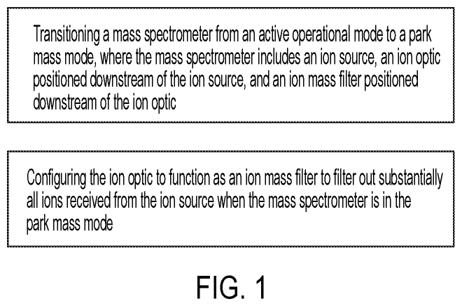

FIG. 1 is a flowchart depicting various steps of one embodiment of the present teachings for operating a mass spectrometer, where the mass spectrometer includes an ion source, at least one ion optic positioned downstream of the ion source and at least one ion mass filter positioned downstream of the ion optic. The method includes transitioning an operational mode of the mass spectrometer from an active mass collection mode to a park mass mode and configuring the ion optic to function as an ion bandpass filter for substantially inhibiting passage of ions generated by the ion source during the park mass mode to the downstream ion mass filter. By way of example, the ion optic can be configured to filter out substantially all ions received from the ion source when the mass spectrometer is in a park mass mode, thereby inhibiting their passage to the downstream ion mass filter. In this manner, the contamination of the downstream ion mass filter can be avoided when the mass spectrometer is idle (i.e., when the mass spectrometer is in a park mass mode).

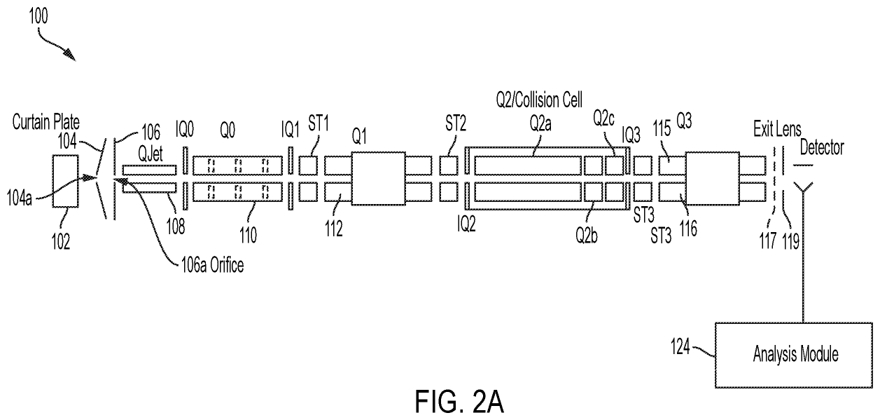

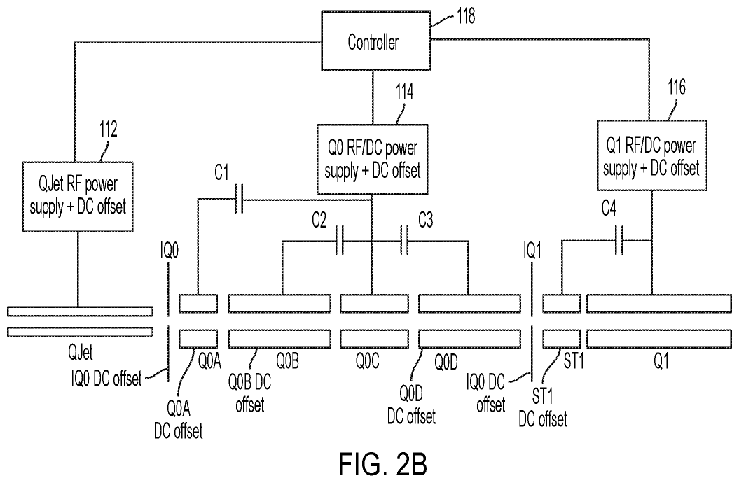

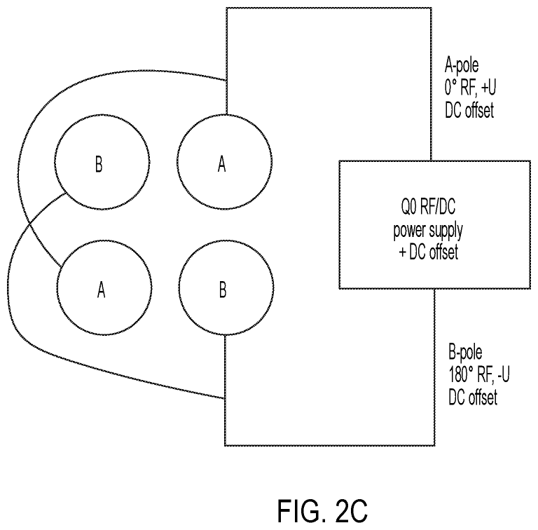

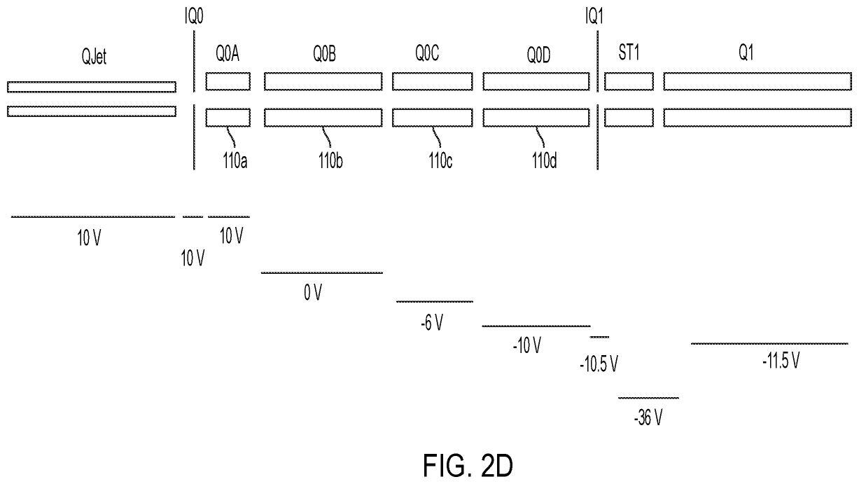

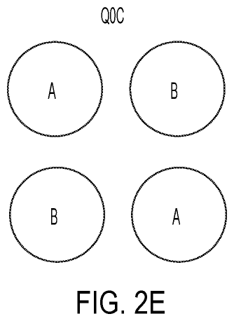

The methods according to the present teachings for operating a mass spectrometer can be implemented in a variety of different mass spectrometers. By way of example, with reference to FIGS. 2A, 2B, 2C, and 2D, a mass spectrometer 100 is configured to operate in accordance with a method according to the present teachings. The mass spectrometer 100 includes an ion source 102 for generating a plurality of ions. A variety of ion sources can be employed in the practice of the present teachings. Some examples of suitable ion sources can include, without limitation, an electrospray ionization device, a nebulizer assisted electrospray device, a chemical ionization device, a nebulizer assisted atomization device, a chemical ionization device, a matrix-assisted laser desorption/ionization (MALDI) ion source, a photoionization device, a laser ionization device, a thermospray ionization device, an inductively coupled plasma (ICP) ion source, a sonic spray ionization device, a glow discharge ion source, and an electron impact ion source, among others.

The generated ions pass through an orifice 104a of a curtain plate 104 and an orifice 106a of an orifice plate 106, which is positioned downstream of the curtain plate and is separated from the curtain plate such that a gas curtain chamber is formed between the orifice and the curtain plate. A curtain gas supply (not shown) can provide a curtain gas flow (e.g., of N₂) between the curtain plate 104 and the orifice plate 106 to help keep the downstream sections of the mass spectrometer clean by de-clustering and evacuating large neutral particles. The curtain chamber can be maintained at an elevated pressure (e.g., a pressure greater than the atmospheric pressure) while the downstream sections of the mass spectrometer can be maintained at one or more selected pressures via evacuation through one or more vacuum pumps (not shown).

In this embodiment, the ions passing through the orifices of the curtain plate and the orifice plate are received by a QJet ion guide, which comprises four rods 108 (two of which are visible in this figure) that are arranged in a quadrupole configuration to form an ion beam for transmission to downstream components of the mass spectrometer. In use, the QJet ion guide can be employed to capture and focus the ions received through the opening of the orifice plate 106 using a combination of gas dynamics and radio frequency fields.

The ion beam exits the QJet ion guide and is focused via a lens IQ0 into a subsequent ion guide Q0. With particular reference to FIG. 2B, in this embodiment, the ion guide Q0 includes four segments Q0A, Q0B, Q0C, and Q0D that are positioned in tandem. Each segment includes four rods 110a, 110b, 110c, and 110d (two of which are visible in the figure), respectively, which are arranged in a quadrupole configuration and to which RF and/or DC voltages can be applied for focusing the ions as they pass through the Q0 ion guide.

More specifically, in this embodiment, an RF voltage source 112 applies RF voltages to the rods of the QJet ion optic to provide radial confinement of the ions passing through QJet. A DC/RF voltage source 114 supplies DC and RF voltages to the rods of the Q0 segments. In this embodiment, the RF voltage is applied to the Q0C segment and the other segments receive RF voltages via capacitive coupling to the Q0C segment. Further, the voltage source 114 supplies offset DC voltages to the Q0A, Q0B, and Q0D segments as well as the ion lens 100.

Further, an RF/DC voltage source 116 supplies RF and DC voltages to the rods of a Q1 mass filter, and via capacitive coupling to the rods of a stubby lens ST1. In addition, the RF/DC voltage source 116 supplies DC offset voltages to the ST1 stubby lens.

By way of further illustration, FIG. 2C depicts the phases of the RF voltages applied to different rods of the quadrupole rod sets so as to generate a quadrupolar electromagnetic field within a space between those rods for providing radial confinement of the ions passing through the space between the rods.

The above voltage sources operate under the control of a controller 118.

Although in this embodiment the multipole rods of the QJet, Q0, ST1 and Q1 are arranged in a quadrupole configuration, in other embodiments other multipole configurations, such as a hexapole or an octupole configuration may be utilized.

In some embodiments, the pressure of the Q0 ion guide can be maintained, for example, in a range of about 3 mTorr to about 10 mTorr.

The Q0 ion guide delivers the ions, via the ion lens IQ1, and the stubby lens ST1, which functions as a Brubaker lens, to the downstream ion mass filter Q1. In this embodiment, the ion mass filter Q1 includes four rods 112 (two of which are visible in this figure) that are arranged in a quadrupole configuration and to which RF and/or DC voltages can be applied. In some embodiments, the Q1 mass filter can be situated in a vacuum chamber that can be maintained, for example, at a pressure in a range of about 0.6 to about 4×10⁻⁵ Torr.

More specifically, in this embodiment, the quadrupole rod set Q1 can be operated as a conventional transmission RF/DC quadrupole mass filter for selecting ions having an m/z value of interest or m/z values within a range of interest. By way of example, the quadrupole rod set Q1 can be provided with RF/DC voltages suitable for operation in a mass-resolving mode. For example, parameters of applied RF and DC voltages can be selected so that Q1 establishes a transmission window of chosen m/z ratios, such that these ions can traverse Q1 largely unperturbed. Ions having m/z ratios falling outside the window, however, do not attain stable trajectories within the quadrupole and can be prevented from traversing the quadrupole rod set Q1. It should be appreciated that this mode of operation is but one possible mode of operation for Q1.

In this embodiment, the ions selected by the Q1 mass filter are focused via an ST2 stubby lens and an ion lens IQ2 into a collision cell Q2. In this embodiment, the collision cell Q2 includes a pressurized compartment that can be maintained, e.g., at a pressure in a range of about 1 mTorr to about 10 mTorr, though other pressures can also be used for this or other purposes. A suitable collision gas (e.g., nitrogen, argon, helium, etc.) can be provided by way of a gas inlet (not shown) to fragment at least a portion of the ions received by the collision cell.

The fragment ions (herein also referred to as product ions) generated in the collision cell Q2 are received after passage through an ion lens IQ3 and stubby lens ST3 by a mass filter Q3. The mass filter Q3 includes four rods 115 (two of which are visible in the figure) that are arranged in a quadrupole configuration and to which RF/DC voltages can be applied. The ions passing through the mass filter Q3 are focused on an ion detector via ion lenses 117 and 119. The ion detector generates ion mass data in response to the detection of ions incident thereon. An analysis module (herein also referred to as an analyzer) 124 receives the ion mass data generated by the ion detector and operates on the ion mass data to generate a mass spectrum of the ions.

During an active operational mode of the mass spectrometer (i.e., when mass data of a sample is being acquired), the RF and DC voltages applied to the Q0 ion guide allow the passage of ions received from the ion source thereto with the RF voltage providing a radial confining field. More specifically, the controller 118 is configured to cause the voltage source 114 to supply only the DC offset voltages with no DC resolving voltage, or a DC resolving voltage appropriate for running the mass spectrometer in the active operational mode, to the Q0C rods.

In response to a transition of the mass spectrometer from an active operational mode to a park mass mode, the controller 118 causes the voltage source 114 to adjust a DC resolving voltage applied to the Q0C rods so as to cause the ions entering the Q0C rods to follow unstable trajectories and thereby be inhibited from reaching the downstream ion mass filter Q1. In this embodiment, the bandpass applied to the Q0C ion optic is maintained during both the operational mode and the park mass mode with the width of the bandpass determined by the type of ions that are being passed through the Q1 and Q3 mass filters. By way of example, and without limitation, the minimum bandpass can be set to about 30 Da and can be synced to the Q1 mass while in the operational mode to remove ions from around the Q1 mass of interest and deposit them on the Q0C rods. This can reduce the number of ions striking the Q1 mass filter (or the Q3 mass filter) to prolong the period of time between cleaning of the ion optics. In the park mass mode, the controller can adjust the resolving DC voltage applied to Q0C ion optic such that the ions would exhibit a Mathieu q parameter value that is in the unstable region, thereby inhibiting the passage of the ions through the QC ion optic.

In embodiments, the controller can be provided with values of voltages for application to various ion optics and as well as for ramping one or more of those voltages. For example, the information can be downloaded from a computer to the controller. The controller can initiate the collection of data during the operational mode based on this information. At the end of a mass analysis run when a “stop” condition is met, the controller can receive another set of predefined RF and DC voltage values for the park mass mode. The “stop” condition can be either downloaded as part of the experimental method or can be manually activated by pushing a “stop” button on the instrument control panel.

By way of further illustration and with reference to FIG. 2E, for each of the four rod sets Q0A, Q0B, Q0C, and Q0D, the rods marked ‘A’ are electrically connected, and are referred to as the A-pole. The rods marked ‘B’ are electrically connected and are referred to as the B-pole.

Only RF and DC offset voltages are applied to the first, the second and the fourth sets of rods Q0A, Q0B and Q0D. The RF signals applied to the first and the second sets of rods Q0A and Q0B provide radial focusing of the received ions through the process of collisional cooling, which in turn results in a smaller radial spread of the ion beam than that at the entrance of the first set of rods Q0A. One advantage of using the two sets of rods Q0A and Q0B, rather than a single rod set having the same length as combination of the two rod sets, is that a DC voltage offset applied between the two sets of rods Q0A and Q0B can help keep the ions moving without losing so much axial kinetic energy that they would come to a stop within that segment. Further, the DC voltage offset applied to the sets of rods Q0C and Q0D is selected to ensure that the ions' axial kinetic energy will be low as they exit the mass filter Q0 region and pass through the lens IQ1 to reach the mass analyzer Q1. This can in turn help with the timing for the filling of the mass filter Q0 and transmission of the ions received by the mass filter Q0 to the downstream mass analyzer Q1.

The segment of the Q0 ion optic that acts as the mass filter is more robust to contamination than either the IQ1 lens or the Q1 mass filter. This is because when contamination builds up on the IQ1 lens, leading to charging of the lens, then the ions are impacted by the charge strongly because the internal aperture of the IQ1 lens (e.g., 0.7 mm) places the charge closer to the ion beam than ion contamination on the Q0C segment, which has a larger field radius (e.g., 4.17 mm). At the IQ1 lens the ions' axial kinetic energy is typically lower (only 0.5 to 2 eV) compared to the axial kinetic energy of the ions entering the Q0C segment (e.g., 3 to 6 eV). The effect of the charge build-up on the contaminated surface also diminishes with distance. The combination of the ions' higher axial kinetic energy and farther distance of the charged surface away from the ion beam reduces the effect of the charge build-up on the ion beam for the Q0C segment when compared to the IQ1 lens.

The same reasoning applies for the Q1 mass filter. Typically, the ions enter the Q1 mass filter with axial kinetic energies on the order of 1 to 1.5 eV. At the lower axial kinetic energy, the charge build-up on the Q1 mass filter has a larger effect on the ions' motion than at the higher axial kinetic energy used for the Q0C segment. A higher axial kinetic energy cannot be used for the Q1 mass filter since a minimum number of RF cycles is required to obtain unit resolution, e.g., FWHM=0.7 Da. When using the Q0C segment as a bandpass filter the minimum bandpass is approximately 20 Da (for singly charged ions) due to the shortness of the Q0C segment (e.g., 40 mm), the presence of the background gas (5 mTorr) and the relaxed mechanical tolerances used in its construction compared to the Q1 mass filter. The relaxed requirements allow the use of the higher axial kinetic energies.

For the third set of rods Q0C, in addition to RF signals being applied for providing radial confinement, DC resolving voltages are also applied across the rods of the third set QC to define the bandwidth window of the mass filter Q0. As noted above, no resolving DC voltages are applied to the rods of the first, second, and fourth sets Q0A, Q0B, and Q0D.

For each rod set (or rod segment), the phase of the RF signal applied to the A-pole is 180° shifted relative to the phase of the RF signal that is applied to the B-pole. Further, for the third set of rods Q0C, the resolving DC voltages applied to the A-pole and the B-pole have opposite polarities. By way of example, in some embodiments, the applied RF voltages can have a frequency in a range of about 500 kHz to about 2 MHz and can have a zero-to-peak voltage in a range of about 500 V to about 10 kV, though other frequencies and/or voltages can also be employed based, e.g., on specific applications.

The choice of the RF drive frequency can depend on the desired mass range, available voltage ranges of the power supplies and the field radius of the quadrupole mass filter. The Mathieu equations, reproduced below, can be used to determine the RF drive frequency based on Mathieu a and q parameters:

$$a = \frac{8 eU}{m {Ω}^{2} {r}_{0}^{2}} \qquad Eq . ( 1 )$$

$$q = \frac{4 e V}{m {Ω}^{2} {r}_{0}^{2}} \qquad Eq . ( 2 )$$

where e represents the ion charge, U represents the DC resolving voltage, V represents the RF drive amplitude, r₀ represents field radius (i.e., the radius of the ion passageway provided by the quadrupole rods), Ω represents the angular drive frequency, and m represents the ion mass.

Table 2 below presents some examples of the above parameters:

TABLE 2

| | | RF Amplitude, zero- | Resolving DC |
|---|---|---|---|
| | | to-peak, pole-to- | voltage, pole-to- |
| Drive | Field | ground at m/z 2000 | ground at m/z 2000 |
| Freq. (Hz) | Radius (mm) | (volts) | (volts) |
| 500,000 | 4.17 | 628 | 105.7 |
| 1,000,000 | 4.17 | 2513 | 422.6 |
| 2,000,000 | 4.17 | 10,051 | 1691 |

In this embodiment, the RF voltage source can apply, for example, an RF signal, e.g., with a frequency and a voltage in the aforementioned ranges to the Q0C segment during active operational mode of the mass spectrometer. The RF voltages for application to the Q0A, Q0B, and Q0D segments are derived, via capacitive coupling, from the Q0C voltage. In this embodiment, the peak-to-zero amplitudes of RF voltages applied to the Q0A, Q0B, and Q0D segments are about 90% of the respective RF voltage amplitude applied to the Q0C segment. The RF voltages generate an electric field for radial confinement of the ions as they pass through various segments of Q0. Further, in this embodiment, the DC voltage source applies the required DC offset voltages depicted in the FIG. 2D to the ion guide QJet and various segments of the mass filter Q0 to generate an axial DC electric field for facilitating the axial movement of the ions through the mass filter Q0.

The DC potential drops between various segments can range, for example, from 0 V, where the ions are not helped in their axial movement, to the optimized potentials shown in FIG. 2D for moving the ions such that the ions will not stop in any of the segments.

The following examples are provided for further elucidation of various aspects of the present teachings and are not provided to indicate necessarily the optimal ways of practicing the present teachings or the optimal results that may be achieved.

### Examples

A modified Sciex Qtrap 6500⁺ mass spectrometer operating in high mass mode (940 kHz drive frequency) was employed for the acquisition of mass data for Reserpine and PPG, as discussed below. The modifications to the mass spectrometer included using a segmented Q0 ion guide, as schematically depicted, e.g., in FIG. 2B operating at a 1 MHz drive frequency. The segmented Q0 ion guide allowed the application of a bandpass to the ion beam passing through the Q0 ion guide so as to reduce the number of ions that are transmitted to the downstream optics, thereby reducing the degree of ion contamination of the downstream optics.

In addition, a DC axial gradient was created by applying appropriate DC offset potentials to the Q0 ion guide segments. As noted above, the use of a segmented Q0 ion guide provides certain advantages. For example, the DC axial gradient generated between the segments allows the ions to be moved quickly through the Q0 ion guide. The bandpass was applied to the Q0C segment using quadrupole RF and resolving DC voltages.

Solutions of Reserpine (0.17 pmol/μl) and PPG (2e⁻⁷ M) were infused at 10 μl/min.

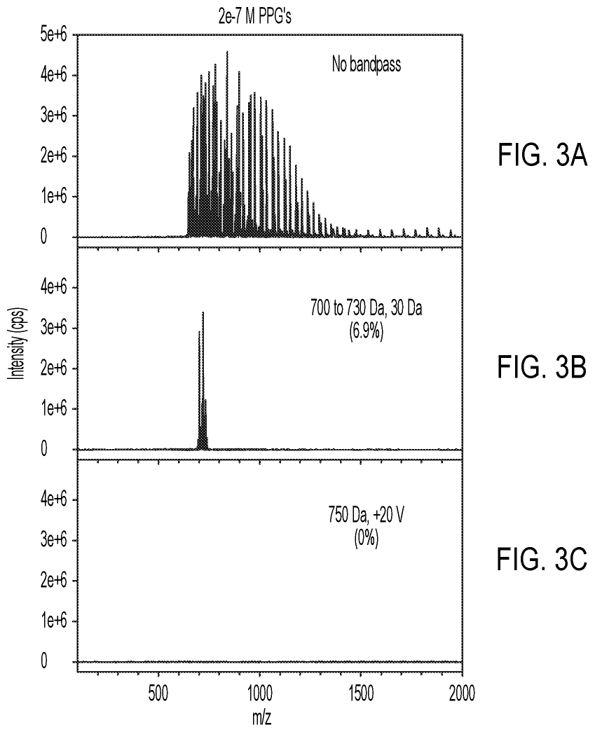

FIG. 3A shows a mass spectrum acquired with the Q0 bandpass turned off. FIG. 3B shows a mass spectrum acquired with the Q0 bandpass set to be 30 Da wide and centered at m/z 715. FIG. 3C shows data acquired with an over-resolved bandpass at m/z 750 via application of 20 V resolving DC voltage above the apex of the stability region. In each spectrum, the Q0 mass setting was held stationary while the Q1 mass setting was scanned from m/z 100 to m/z 2000. In FIGS. 3A and 3B, the Q0 mass setting was chosen to be 703 Da, which was required to produce the bandpass in FIG. 3B via application of a 140 V resolving DC voltage. As noted above, in FIG. 3A, the resolving DC voltage was set to zero.

The data presented in FIG. 3B shows that only about 6.9% of the ions in FIG. 3A were transmitted through the Q0C segment with the 30 Da wide bandpass applied to Q0C segment.

The spectrum depicted in FIG. 3C shows that with the Q0 mass setting at 750 Da and the resolving DC voltage increased by 20 V beyond the apex of the first stability region, no ions were transmitted beyond the Q0C segment. In other words, in this case, no ions were striking and contaminating the ion optics downstream of the Q0C segment.

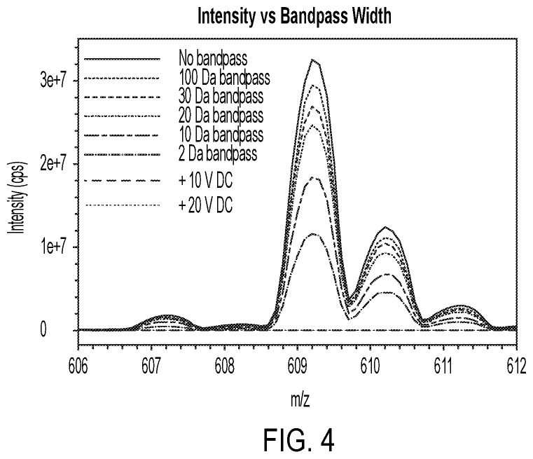

FIG. 4 shows data that was collected by setting the Q0 bandpass centered on m/z 609 while the Q1 mass filter was scanned from m/z 606 to 612 at 10 Da/s. The bandpass was varied from no bandpass to 100 Da wide bandpass to a 2 Da wide bandpass. The resolving DC voltage was then increased by 10 and 20 V while the Q0 mass setting remained at the setting used for the 2 Da wide bandpass. The length of the Q0C segment was 40 mm, the ions entered the Q0C segment with 6 eV of kinetic energy and Q0 was filled with 5.3 mTorr of nitrogen. Under these conditions, the boundaries of the stability diagram become distorted, though the distortions can be calibrated out. As a result, even though the bandpass parameters were calculated to provide a 2 Da wide bandpass, ions across 6 Da range were still transmitted but at a reduced intensity.

It was observed that as the Q0 bandpass width was decreased, there was a corresponding decrease in the number of transmitted ions. For example, the signal intensity for m/z 609.2 decreased to 91% for a 30 Da wide bandpass as compared to no bandpass. When the resolving DC voltage was increased further by 10 and 20 V relative to the resolving DC voltage used for the 2 Da bandpass, no ions were transmitted.

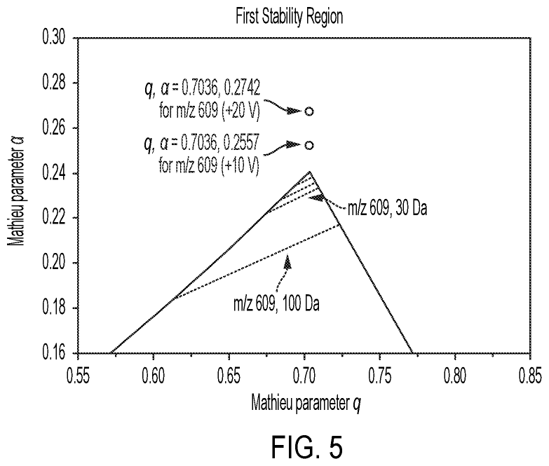

FIG. 5 shows the scan lines for the bandpass windows of FIG. 4 along with the calculated Mathieu parameter q, a values for the increased resolving DC which reside outside of the stability region shown by the enclosed triangle. Inside the triangle region the ion trajectories are stable and are transmitted through the Q0C segment. Ions that have a and q values outside of the triangle have unstable ion trajectories and end up striking the rods of Q0C.

In those cases, no ions will be transmitted through the Q0C segment. The scan lines can be interpreted as identifying the allowable a and q values for the transmitted ions were between the intercepts of the scan lines with the stability region boundaries. All of the ions that were transmitted had Mathieu a and q values that lie along the scan line for a particular bandpass width.

### Park Mass Mrm Experiments

Several MRM (multiple reaction monitoring) experiments were carried out to examine the effect of setting the Q0 ion guide at the park mass mode on the MRM intensities. Table 1 below provides the results of three different MRM experiments for the transition 609 to 195 at a collision energy of 40 eV. All experiments were carried out at dwell times of 2 ms and 20 ms with a 3 ms pause time. The choice of the minimum pause and dwell times was based on the recommended minimum times for the 6500⁺ mass spectrometer.

TABLE 1

| | | Intensity | | Intensity | |
|---|---|---|---|---|---|
| | | mrm 609 to 195, | | mrm 609 to 195, | |
| | | pause = 3 ms, | | pause = 3 ms, | |
| Line | Experiment | dwell = 2 ms | | dwell = 20 ms | |
| | Exp. #1 | | | | |
| 1 | 30 Da Q0 bandpass at | 1.33 e6 | cps | 1.62e6 | cps |
| | m/z 609 | | | | |
| | Exp. #2 | | | | |
| 2 | Q0 at m/z 750 + 20 V | 1.12e4 | cps | 9.51e3 | cps |
| | res DC | | | | |
| 3 | 30 Da Q0 bandpass at | 1.34e6 | cps | 1.63e6 | cps |
| | m/z 609 | | | | |
| | Exp. #3 | | | | |
| 4 | Q0 at m/z 900 + 20 V | 94.5 | cps | 87.9 | cps |
| | res DC | | | | |
| 5 | 30 Da Q0 bandpass at | 1.32e6 | cps | 1.60e6 | cps |
| | m/z 609 | | | | |

During the pause time, the Q3 mass was dropped to 10 Da for the first millisecond of the pause time before returning to m/z 195 for the purposes of emptying the Q2 collision cell of any un-transmitted m/z 195 from the previous measurement. The DC offset on ST3 was also brought to zero volts at the same time to remove any trapped ions within ST3, though this step was not necessary since both the ST1 and ST3 ion optics were rotated 37.5° and had reduced field radii to prevent ion trapping.

In the first experiment, the Q0 bandpass was set at 30 Da and was centered on m/z 609. The signal intensity at a dwell time of 2 ms was 82% of that for a dwell time of 20 ms.

In the second experiment, the Q0 bandpass was set at m/z 750 with 20 V of resolving DC voltage added to prevent any transmission downstream of the Q0C segment (see Line #1 of the Table). In this experiment, the Mathieu q value for m/z 609 was 0.92 in segments Q0A and Q0B, which means that ions with m/z 609 were unstable in the first two segments of the Q0 ion guide as well as in the Q0C segment. Ions with a Mathieu y parameter above 0.908 were unstable in the quadrupole. The Mathieu q value for Q0D segment was 0.79, which means that ions with m/z 609 were still stable in the last segment and hence residual m/z 609 could still be present. These values indicate that the entire Q0 ion optic needs to be refilled before performing the following MRM measurement (Line #3) with a 30 Da bandpass window centered at m/z 609. Otherwise, the signal intensity would be reduced.

With continued reference to Table 1, the signal intensities at Line #3 are identical to those at Line #1 for both the 2 ms and 20 ms dwell times indicating that the Q0 ion optic was capable of refilling completely with 3 ms pause time. It should be noted that during the measurements performed with parameters indicated on Line #2, the Q1 and Q3 mass filters remained at m/z 609 and m/z 195, respectively and only the potentials applied to the Q0 ion optic were changed. The relative signal intensities of measurements associated with Line #2 were less than 1% of the signal intensities of measurements associated with Line #3.

Increasing the Q0 bandpass set mass to m/z 900 with 20 V of added resolving DC voltage beyond the apex of the stability region brought the Mathieu q parameter for m/z 609 up to 1.11 in segments Q0A and Q0C and up to 0.95 in Q0D segment. Again, this means that the Q0 region needs to be completely refilled prior to the next measurement. The intensity results at Line #5 are identical to those at Lines #1 and #3, indicating that the Q0 ion optic was completely refilled during the 3 ms pause time. The signal intensities associated with parameters used at Line #4 were less than 0.01% of those associated with the parameters used at Lines #1, #3, and #5. The intensity at Line 4 is less than that at Line 2 indicating that no residual m/z 609 remained in the Q0D segment with the set mass at 900. Increasing the q value on Q0D removed any residual m/z 609 for Q0D.

Without being limited to any particular theory, it is believed that the reproducibility of the signal intensities for the three experiments is the result of the speed of the refill of the Q0 ion optic due to the axial gradient within the Q0 ion optic provided by the DC offsets shown in FIG. 2B, and the use of rotated ST1 and ST3 ion optics.

### Expected Ion Deposition

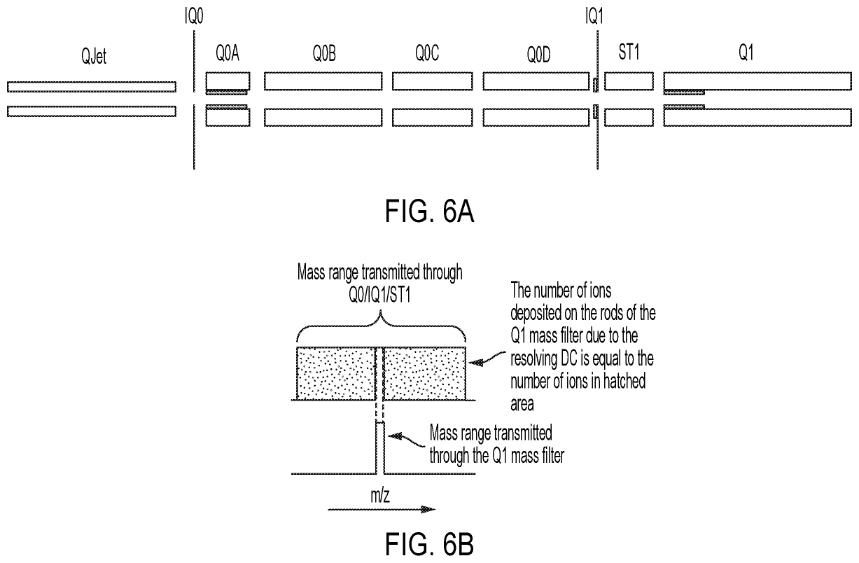

FIG. 6A shows the locations along the ion path as the ions travel through Q0 and Q1 at which ions are expected to be deposited when Q0 is operated without a bandpass ion transmission window applied to the Q0C segment. The expected ion deposition locations are marked with hatched lines. Ions entering Q0A that have Mathieu q values greater than 0.908 are expected to be deposited upon the Q0A ion optic. With no bandpass applied, all of the ions with Mathieu q values less than 0.908 are expected to be transmitted to the IQ1 ion optic where ions near the low mass cut-off (q=0.908) may be lost on the lens. The remaining ions will be transmitted to the Q1 mass filter and those ions not transmitted by the Q1 mass filter will be deposited upon the quadrupole rods. The areas of contamination are expected to be the same for a Q0 ion guide that is not segmented.

FIG. 6B schematically shows that fraction of ions passing through the Q0, IQ1 and ST1 that are expected to be deposited on the Q1 mass filter in the configuration depicted in FIG. 6A.

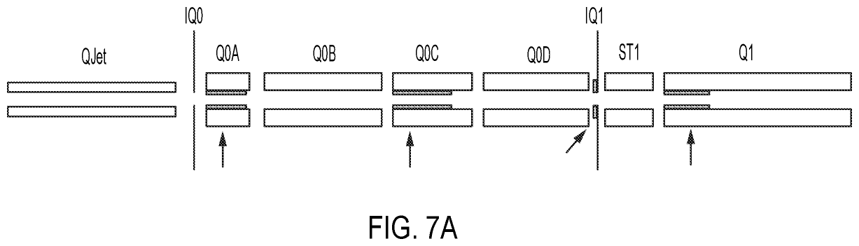

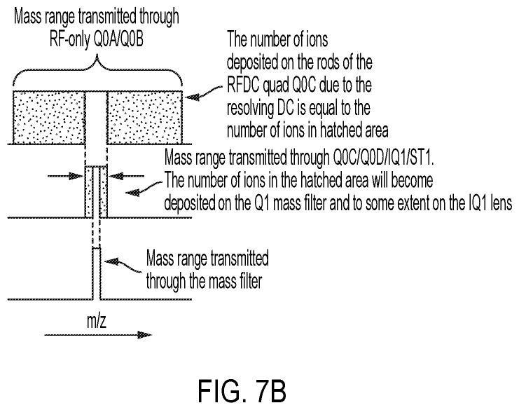

FIGS. 7A and 7B schematically depict the expected deposition of ions along their propagation path when a bandpass is applied to the Q0C segment to inhibit passage of a portion of ions through the Q0 ion guide. In this case, it was assumed that the same number of ions was transmitted into the Q0 region as that in FIG. 6A. The deposition of ions still occurs at Q0A. In addition, the filtering of the ions by the Q0C segment results in the deposition of a significant portion of the ions onto the Q0C rods. Ions having m/z ratios within the bandpass of the Q0C segment are transmitted through the Q0C segment and will be deposited on the IQ1 and Q1, albeit at a much smaller fraction compared to the case where no bandpass was applied to the Q0C segment. This in turn results in a much lower contamination of the IQ1 and Q1 ion optics compared to the case in which no bandpass was applied to the Q0C segment.

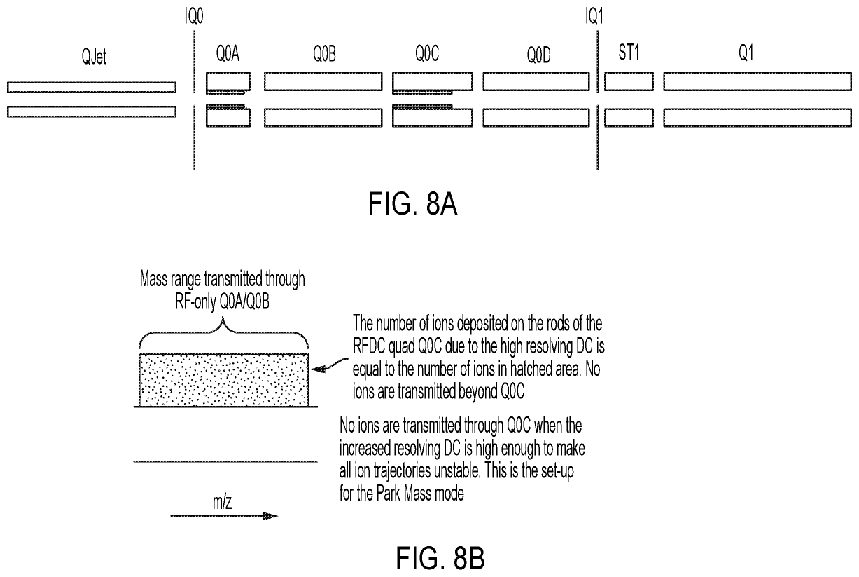

FIG. 8A schematically represents expected ion deposition on Q0A and Q0C segments when the resolving DC voltage applied to the Q0C segment is increased so that all ions are unstable as they pass through the Q0C segment. This case corresponds to the park mass mode in which no ions are transmitted beyond the Q0C ion optic. The expected ion deposition on the Q0A segment is still similar to that shown in the previous cases, but the Q0C segment is expected to receive the remainder of the ions, thereby inhibiting the passage of the ions to the downstream ion mass filter. In other words, in this case, there is no ion deposition on the IQ1 and Q1 ion optics and hence no contamination of these components in the park mass mode.

FIG. 8B schematically depicts that no ions are transmitted through the Q0C segment.

As used herein the term “and/or” includes any and all combinations of one or more of the associated listed items and may be abbreviated as “/”. Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a processor, a microprocessor, a programmable computer or an electronic circuit. In some embodiments, some one or more of the most important method steps may be executed by such an apparatus.

Depending on certain implementation requirements, embodiments of the invention can be implemented in hardware and/or in software. The implementation can be performed using a non-transitory storage medium such as a digital storage medium, for example a floppy disc, a DVD, a Blu-Ray, a CD, a ROM, a PROM, and EPROM, an EEPROM or a FLASH memory, having electronically readable control signals stored thereon, which cooperate (or are capable of cooperating) with a programmable computer system such that the respective method is performed. Therefore, the digital storage medium may be computer readable.

While various embodiments have been illustrated and described in detail in the drawings and foregoing description, such illustration and description are to be considered illustrative or exemplary and not restrictive; embodiments of the present disclosure are not limited to the disclosed embodiments. Other variations to the disclosed embodiments can be understood and effected by those skilled in the art in practicing embodiments of the present disclosure, from a study of the drawings, the disclosure, and the appended claims.

In the claims, the word “comprising” does not exclude other elements or steps, and the indefinite article “a” or “an” does not exclude a plurality. A single processor or other processing unit may fulfill the functions of several items recited in the claims. The mere fact that certain measures are recited in mutually different dependent claims does not indicate that a combination of these measured cannot be used to advantage. Any reference signs in the claims should not be construed as limiting the scope.

Those having ordinary skill in the art will appreciate that various changes can be made to the above embodiments without departing from the scope of the present teachings.

What is claimed is:

1. A method of operating a mass spectrometer having an ion source, at least one ion optic positioned downstream of the ion source and at least one ion mass filter positioned downstream of the ion optic, comprising:
transitioning an operational mode of the mass spectrometer from an active mass collection mode to a park mass mode, and
configuring the ion optic to function as a bandpass ion mass filter for substantially inhibiting passage of ions generated by the ion source during the park mass mode to the downstream ion mass filter.

2. The method of claim 1, wherein said ion optic comprises a plurality of rods arranged in a multipole configuration.

3. The method of claim 2, wherein said multipole configuration comprises any of a quadrupole, a hexapole and an octupole configuration.

4. The method of claim 2, wherein the step of configuring the ion optic to function as a bandpass filter comprises applying an RF voltage and a DC resolving voltage to at least one of said plurality of rods.

5. The method of claim 1, wherein the step of configuring the ion optic to function as a bandpass ion mass filter comprises configuring the ion optic to function as an over-resolved ion mass filter.

6. The method of claim 1, wherein said ion optic has a segmented structure comprising a plurality of ion optic segments positioned in tandem relative to one another, wherein each segment comprises a plurality of rods arranged in a multipole configuration.

7. The method of claim 6, wherein the step of configuring said ion optic to function as a bandpass filter comprises applying an RF voltage and a DC resolving voltage to the rods of at least one of said segments.

8. The method of claim 6, further comprising applying one or more DC offset voltages to said ion optic segments.

9. The method of claim 8, wherein said DC offset voltages are configured to accelerate ions entering the segmented ion optic.

10. A mass spectrometer, comprising:
an ion source for receiving a sample and ionizing at least a portion of the received sample to generate a plurality of ions,
an ion optic positioned downstream of said ion source for receiving said plurality of ions and focusing said ions to form an ion beam,
an ion mass filter positioned downstream of said ion optic for receiving said ion beam, a controller in communication with said ion optic,
wherein said controller is configured to adjust a DC resolving voltage applied to said ion optic such that the ion optic provides a bandpass filter for substantially inhibiting passage of the received ions to the downstream ion mass filter when said mass spectrometer is in a park mass mode.

11. The mass spectrometer of claim 10, wherein said ion optic comprises a plurality of rods arranged in a multipole configuration and wherein said DC resolving voltage is applied to said plurality of rods.

12. The mass spectrometer of claim 11, further comprising a DC voltage source operating under control of said controller for applying said DC resolving voltage to said rods.

13. The mass spectrometer of claim 11, further comprising an RF voltage source operating under control of said controller for applying an RF voltage to at least one of said plurality of rods for providing radial confinement of ions passing through the ion optic.

14. The mass spectrometer of claim 11, wherein said ion optic comprises a plurality of segments positioned in tandem relative to one another.

15. The mass spectrometer of claim 14, wherein said resolving DC voltage is applied to at least one of said segments.

16. The mass spectrometer of claim 10, wherein said ion optic comprises a plurality of rods arranged in a multipole configuration and wherein said DC resolving voltage is applied to one of said rods.

17. The mass spectrometer of claim 14, wherein said controller causes said DC voltage source to apply DC offset voltages to said plurality of segments.

18. The mass spectrometer of claim 17, wherein said DC offset voltages are configured to accelerate ions passing through the ion optic.
